(19) United States
(12) Patent Application Publication
(10) Pub. No.: US 2026/0010839 A1
(43) Pub. Date: Jan. 8, 2026

(54) SYSTEM AND METHOD FOR INTEGRATIVE MANAGEMENT OF GOLF COURSE RESERVATION

(71) Applicant: Deok Woo KIM, Seoul (KR)

(72) Inventor: Deok Woo KIM, Seoul (KR)

(21) Appl. No.: 18/859,665

(22) PCT Filed: Feb. 15, 2023
(86) PCT No.: PCT/KR2023/002216

§ 371 Date: Jul. 11, 2025

(30) Foreign Application Priority Data
Apr. 26, 2022 (KR) 10-2022-0051255

(51) Int. Cl. G06Q 10/02

(52) U.S. Cl. CPC G06Q 10/026

(57) ABSTRACT

A system and a method for integrative management of a golf club reservation are disclosed. The system contains a user terminal which performs a communication network connection and data input/output function; a reservation app installed in the user terminal to be executed; a golf course server in which a golf course reservation site accessible by the user terminal through a communication network is constructed; and a management server connected to the user terminal and the golf course server through the communication network.

### TECHNICAL FIELD

The present invention relates to an information and communications technology (ICT)-based data processing technology, and more particularly, to a technology for providing golf reservation services by including a golf course server, a user terminal, a reservation app, a management server, a communication network, etc.

### BACKGROUND ART

As golf becomes more popular, various methods of providing golf reservation services (such as golf reservation service apps) are emerging, but are generally limited to simple functions of searching for a desired date, time, region, golf course name, etc., to check if there are tees available for reservation.

However, since each golf course has different operating regulations, golf courses may be categorized into three types: golf courses where reservations have not yet started, even if there are tees available on the desired rounding date, golf courses where reservations have started but there are no tees available for reservation, and golf courses where reservations have started and also there are tees available for reservation.

Most golf reservation services target only cases where reservations have started among the above three types, which is very inconvenient for users. In other words, if a user wants to go to a specific golf course but there are no tees available for reservation, the user should periodically visit a golf reservation service app, or a reservation site on a homepage of the specific golf course (hereinafter referred to as a “golf course reservation site”), to check if there are tees available for reservation. Also, if the reservation for the golf course the user wants to go to has not yet started, the user should check the time when the reservation starts and access the golf course reservation site at that time to make a reservation.

The problem is that since there are many golf courses, it is not easy for the user to check a reservation start time point, set an alarm, and wait, and it is not easy to visit golf reservation agency services (for example, Kakao Golf or SBS Golf in Korea) or golf course reservation sites one by one to check if there are tees available for reservation.

In addition, users who golf often use the golf reservation agency services, but these golf reservation agency services only arrange reservations for golf courses with which they have contracts, and quite a many golf courses that users have signed up for as members do not have contracts and therefore do not provide reservation services.

In addition, many golf courses offer green fee discounts and induce membership registration, and thus, as golf experience of golfers increases, the number of golf course reservation sites they have signed up for increases. However, since the security policy is different for each golf course reservation site, it is difficult to manage password or identification (ID) in a unified manner, so in many cases, it is inconvenient to have to write the password or ID down separately and manage the password or ID. Therefore, when users want to make a reservation at the golf courses, they often have to search for golf courses that are available for reservation on that date and enter the ID and password separately to check.

### DISCLOSURE

### Technical Problem

In order to resolve the inconvenience of the conventional golf reservations, the present invention provides a system for integrative management of golf course reservations capable of providing users with various reservation situations for each golf course at once by simply specifying search conditions, automatically processing membership registration for golf courses that users have not signed up for, and managing different user identification information for each golf course.

### Technical Solution

1. According to one of the main features of the present invention, a system for integrative management of golf course reservation collects information on a reservation status of a golf course, and when a user designates a search condition such as a desired rounding date, it provides the user with the following three types of guidance information according to the reservation status of the golf course.
Real-time reservation guidance information: Guidance information on tee times available for reservation of golf courses for which reservation has already started at a current time, the user may refer to the real-time reservation guidance information to make a reservation right away.
Reservation waiting guidance information: Guidance information on unavailable tee times for golf courses for which reservation has already started at the current time point, when the user sets to receive a reservation availability notification by referring to the reservation waiting guidance information, the user may receive a reservation availability notification when a reservation becomes available later.
Reservation start time point guidance information: Guidance information on reservation start time points (reservation opening time points) of golf courses for which the reservation has not yet started at the current time point. When the user sets to receive a reservation start notification by referring to the reservation start time point guidance information, the user may receive the reservation start notification when the reservation starts.

Some golf course reservation sites allow users to input their desired round date in the form of a waiting reservation, but are not easy to use because they do not automatically search and notify users in the form of an alarm, but usually ask if they want to make a reservation by phone. Moreover, the reservation start notification function may not be found anywhere. In the system for integrative management of golf course reservation of the present invention, the user simply inputs the desired rounding date, and the user is provided with three types of golf course reservation guidance information as follows, thereby providing convenience in making golf course reservations.

First, the real-time reservation guidance information is guidance information on the golf course with tees available for reservation, with which the user may make a reservation at the corresponding golf course in the system for integrative management of golf course reservation of the present invention.

Second, in the case where the user wants to play golf at a specific golf course but there are no tees available for reservation, the user may receive a reservation availability notification with the reservation waiting guidance information, which is a notification of whether there are tees available for reservation at the corresponding golf course. Normally, when a reservation fails, the user should periodically visit the reservation site of the corresponding golf course to check if someone has canceled and there are tees available for reservation, which is very cumbersome and time-consuming. Therefore, the reservation availability notification function, which automatically checks if someone has canceled and there are tees available for reservation and notifies the user if there are tees available for reservation, is a great advantage because it eliminates the inconvenience of having to input IDs and passwords for each golf course reservation site one by one and search for reservation availability. A user may set to be notified of reservation availability notifications with desired conditions. However, when multiple users set to be notified of reservation availability notifications with the same conditions, a method of processing this case is required. The simplest method is to notify the reservation availability notification in order from the user who first sets the reservation when the tees available for reservation occur. In this case, the system for integrative management of golf course reservation may notify the users of their notification sequence number when they request to set the reservation availability notification. Furthermore, when the system for integrative management of golf course reservation provides the user with the entire reservation availability notification setting status, it will be more convenient because competition among multiple users will be distributed.

Third, reservation start time point guidance information may resolve the inconvenience caused by different reservation opening (starting) time points for each golf course, and is generated by referring to reservation regulations of golf courses. That is, when a user inputs a desired rounding date to the system, the system may look up the reservation start time points for each golf course and generate and provide the reservation start time point guidance information for the golf courses where the reservations for the desired rounding date have not yet started. Meanwhile, the reservation start notification setting can be set, for example, as “5 minutes before reservation opening time, 10 minutes before . . . ” In this case, a screen connected to the reservation site of the corresponding golf course may be provided to the user. In addition, the system may automatically input additional information that needs to be input on the reservation site connection screen to help make a quick reservation. Even in this case, when the reservation start notification setting status (e.g., the number of setters) is provided to the users as a whole, it will be more convenient because competition among multiple users will be dispersed.

The integrated golf course reservation management system of the present invention collects information on the reservation status of the golf course and makes a reservation using one of two methods.

The first method is similar to general reservation agency service providers, and involves collecting reservation status information or making a reservation by communicating with the server managing the reservation information of the golf course according to the protocol. In this case, an appropriate application program interface (API) should be placed between the server managing the reservation information of the golf course and the management server of the system of the present invention. This method is possible in a situation where a special agreement is made with the golf course, but since the reservation information of the golf courses may be provided to an unspecified number of people who are not golf course members, the preference of the golf courses is low.

The second method is to directly obtain the information on the reservation status from the golf course reservation site without the API. This method does not require the development of the API, but since the composition method of the golf course reservation site is different for each golf course and the web page should be analyzed, a special access method is required. However, since the access through the web page is only available to golf course members, it is a great advantage for golf courses because the reservation information may be provided only to golf course members. To this end, the system for integrative management of golf course reservation according to the present invention analyzes golf course reservation sites and generates an information processing module that includes an access path and an access method for obtaining desired information from the golf course reservation sites. By using the information processing module generated in this way, each golf course reservation site is accessed individually, and the guidance information is collected and provided to the user, so that the user may receive the reservation status of the golf courses at once as the three types of guidance information.

It is preferable that the information processing module be implemented in the form of a program, because each golf course reservation site has a different structure and information display method, so it is necessary to generate information processing modules for each site. In addition, the information processing module may be generated in the form of a combination of data and program code. In other words, the information processing module may be generated by finding a related uniform resource locator (URL) that accesses the golf course reservation site server, generating the access path, and searching for hyperlinks in web pages on the access path, etc. At first glance, this may seem similar to crawler software, but the information processing module of the present invention includes the data and program code that may be input to the web page, if necessary. In other words, on some pages, specific data should be input to a specific location to move to another page, but since this is a result of understanding and analyzing the web page as a whole, it is not easy to give this function to a general crawler.

Meanwhile, once the information processing module is generated, when the composition of the golf course reservation site changes slightly, it may be generated by executing an information processing module extraction AI program that analyzes the meaning of sentences or words, tags, etc., using artificial intelligence techniques on the management server. However, a site configuration information check program that checks whether the configuration of the golf course reservation site has changed and reports this to the administrator may be simply executed, and if the configuration has changed, the administrator may analyze the site configuration information and directly generate the information processing module.

In addition, by using the information processing module, the system for integrative management of golf course reservation of the present invention may make golf reservations very convenient by automatically logging in to these golf course reservation sites if necessary, collecting the above-described guidance information, and providing the collected guidance information to the user when the user registers the IDs and passwords of the golf course reservation sites where he or she is a member in the system, even if the API for each golf course is not implemented.

Although there have already been services (e.g., Google Chrome or Microsoft Edge) that manage IDs and passwords, and provide services that remember and input the passwords and IDs, there is no service that searches for information on the sites where the IDs and passwords are input, collects the information that the user needs based on keywords (e.g., tee-off date and time, etc.), and organizes the collected information so that the collected information may be viewed at a glance. This is because the task of analyzing the meaning of the information and analyzing and organizing the information by keyword is not a task of simply searching for and listing the information.

In conclusion, the system for integrative management of golf course reservation of the present invention may collect reservation information regardless of whether the user is a member by communicating with a server managing a golf course reservation site through the API, and for golf courses of which the user is a member, may log in using the information processing module, for example, an automatic login unit, and collect information necessary for reservation through the information processing module, for example, a reservation management unit. The collected information is processed into a form that the user may view at a glance and provided to the user as the real-time reservation guidance information, reservation waiting guidance information, and reservation start time point guidance information. The user proceeds with a reservation by referring to such reservation guidance information.

Meanwhile, in order to use the present system, separate user identification information may be input, or one of the IDs and passwords of golf course reservation sites where the user has already registered as a member may be used as identification information.

2. Another possible issue is that, when information is collected by directly visiting individual golf course reservation sites as described above, there may be a situation where a new membership registration is required for a specific reservation site.

Therefore, according to another feature of the present invention, the system for integrative management of golf course reservation divides golf courses into registered golf courses where the user has registered as a member of the golf course reservation site and has a user account and non-registered golf courses where the user does not have an account, and provides reservation information only on the registered golf courses. When there are tees available for reservation at the non-registered golf course and the user wishes to make a reservation there, the user should generate a new user account on that golf course reservation site and provide the generated user account to the system for integrative management of golf course reservation of the present invention to register. In reality, the user should input personal information to register as a member and generate an account, and in some cases, the user should also go through identity verification. While this method is not a big problem when the number of golf courses is limited, as the number of golf courses increases, it becomes difficult to manage IDs and passwords.

For such cases, the system for integrative management of golf course reservation of the present invention may be provided with a function to automatically register as a member of a non-registered golf course and generate a user account. The system for integrative management of golf course reservation may store information (e.g., user's phone number, email address, specific characters or symbols, etc.) that constitutes the user's IDs and passwords in advance in case of a new registration at a non-registered golf course, and may automatically apply for membership at a non-registered golf course to create a user account, if necessary. In this case, the ID of the user account may be automatically generated using one of the user's phone number or email address, and the password may be automatically generated by combining a specific character or symbol provided by the user in advance with the phone number or email address as an extension. A user account of a specific golf course automatically generated in this way may be recorded in the system for integrative management of golf course reservation of the present invention.

The concept of the present invention described above will become more apparent through specific embodiments to be described later with reference to drawings.

### Advantageous Effects

According to the present invention, when a user executes the system for integrative management of golf course reservation, the system collects three types of guidance information from golf course reservation sites that users have signed up for and provides the three types to the users, thereby making golf reservations very convenient. In addition, the system can automatically sign up for golf course reservation sites that users have not signed up for to collect the guidance information and provide the collected guidance information to the users.

### DESCRIPTION OF DRAWINGS

FIG. 1a is a schematic diagram of a system for integrative management of golf course reservation according to the present invention.

FIG. 1b is an exemplary configuration diagram of an information processing module.

FIG. 2 is a schematic operation flowchart of the system for integrative management of golf course reservation according to the present invention.

FIG. 3 is a diagram illustrating additional components of a reservation app illustrated in FIG. 1a.

FIG. 4 is a diagram illustrating additional components of a management server illustrated in FIG. 1a.

FIG. 5 is a diagram illustrating additional components of the management server illustrated in FIG. 4.

FIG. 6 is a diagram illustrating additional components of the reservation app illustrated in FIG. 3.

FIG. 7 is a diagram illustrating additional components of the reservation app illustrated in FIG. 6.

FIG. 8 is a diagram illustrating additional components of the reservation app illustrated in FIG. 7.

FIG. 9 is a diagram illustrating additional components of the management server illustrated in FIG. 8.

FIG. 10 is an exemplary diagram of guidance information collected by the management server from a registered golf course.

FIG. 11 is an exemplary diagram of guidance information displayed on a display of a user terminal.

FIG. 12 is an exemplary diagram of guidance information collected by the management server from registered and non-registered golf courses.

### BEST MODE

Hereinafter, exemplary embodiments of the present invention will be described in detail with reference to the accompanying drawings. The terms used in the following description are intended to describe preferred embodiments of the present invention and are not intended to limit the present invention. Unless otherwise stated, a singular form includes a plural form in the present specification. In addition, components, steps, operations, and/or elements described by the terms “comprise, comprising, and the like” used herein do not exclude the existence or addition of one or more other components, steps, operations, and/or elements.

### <Basic Architecture>

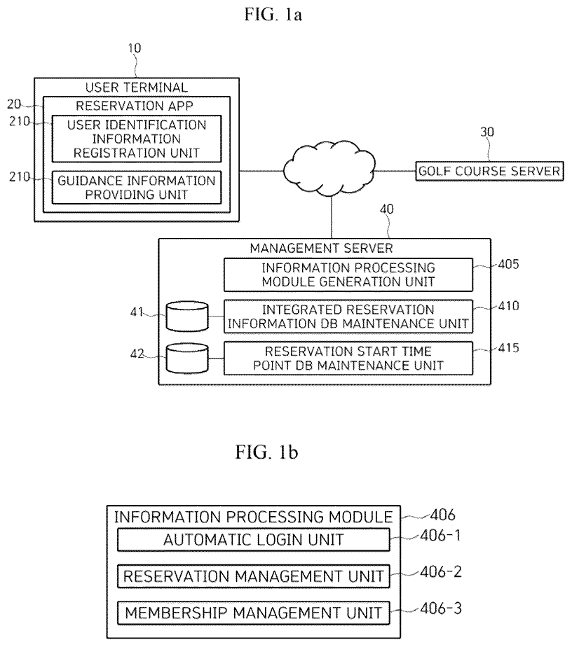

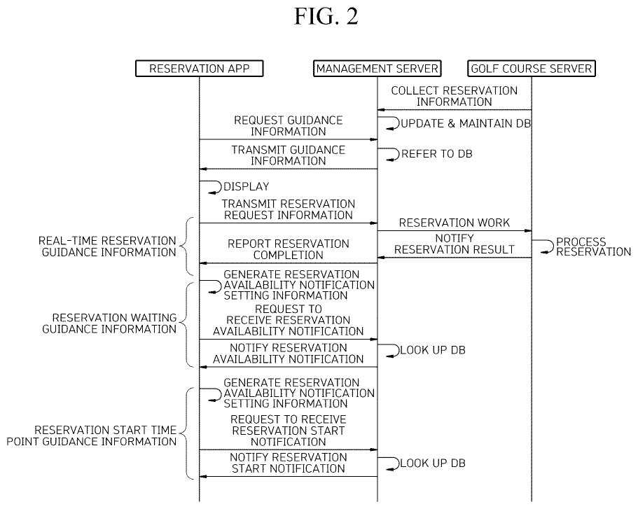

FIG. 1a is a schematic diagram of a system for integrative management of golf course reservation according to the present invention, FIG. 1b is a configuration diagram of an information processing module, and FIG. 2 is a schematic operation flowchart of the system of the present invention.

First, referring to FIG. 1a, the system for integrative management of golf course reservation includes user terminals 10 such as a mobile phone, a tablet computer, and a persona computer (PC) having a computer structure that performs a communication network connection and data input/output function; a reservation app 20 installed in the user terminal 10 to be executed; a golf course server 30 in which a golf course reservation site accessible by the user terminal 10 through a communication network is constructed; and a management server 40 connected to the plurality of user terminals 10 and the golf course server 30 through the communication network and managing the system for integrative management of golf course reservation.

In the above [Means for Solving Problem] section, according to the system for integrative management of golf course reservation according to the present invention, when a user inputs a desired round date to the reservation app 20 of the user terminal 10, the management server 40 transmits three types of guidance information corresponding to the input round date to the reservation app 20—that is, 1) Real-time reservation guidance information: Information for guiding tee times available for reservation of golf courses for which reservation is already started at a current time point. A user may make a reservation right away by referring to the information. 2) Reservation waiting guidance information: Information for guiding tee times unavailable for reservation of the golf courses for which reservation is already started at the current time point. When a user refers to the information and sets to receive a reservation availability notification, the user may receive a reservation availability notification when reservations become available in the future. 3) Reservation start time point guidance information: Information that provides guidance on the reservation start time point (reservation opening time) of golf courses where reservations have not yet started. When the user sets to receive reservation start notification by referring to the information, he or she may receive the reservation start notification when the reservation starts.

Here, the reservation waiting guidance information may include information (e.g., the number of people who have set to receive the reservation availability notifications) that may identify the reservation waiting status. In addition, the reservation start time point guidance information may include information (e.g., the number of people who have set to receive the reservation start notification) on people waiting for the reservation start time point. Here, when the reservation start notification is requested to be received, the time at which the reservation start notification is notified may be set earlier than the time at which the reservation actually starts (opens).

The management server 40 communicates with the golf course server 30 and the user terminal 10, and includes an integrated reservation information database (DB) maintenance unit 410 that collects reservation information such as reservation status and other information related to reservations required for golf course reservations in real time and maintains an integrated reservation information DB 41 in an up-to-date state and a reservation start time point DB maintenance unit 415 that maintains a reservation start time point DB 42, where the reservation start time points of golf courses are stored among the collected information, in an up-to-date state.

In addition, the management server 40 may include an information processing module generation unit 405 that generates the above-described information processing module 406 (FIG. 1b) that is periodically executed to collect guidance information from reservation sites constructed on the golf course server 30.

The management server 40 collects the pieces of guidance information from the golf course reservation sites constructed on the golf course server 30. To this end, the management server 40 may periodically execute the information processing module 406 for each golf course reservation site or collect guidance information through a communication task using an application programming interface (API) with the golf course server 30. The collected guidance information is stored in the integrated reservation information DB 41 and the reservation start time point DB 42 and is maintained in an up-to-date state. The guidance information is collected according to search conditions received from the reservation app 20 and provided to the reservation app 20.

The reservation app 20 includes a guidance information providing unit 220 that receives guidance information (i.e., real-time reservation, reservation waiting, and reservation start time point guidance information) collected and transmitted by the management server 40 and displays the received guidance information on the user terminal 10 to provide the received guidance information to the user. The guidance information providing unit 220 may additionally include a function of sorting the guidance information transmitted by the management server 40 by keywords such as date, time, region, and golf course name previously input by the user before displaying the guidance information transmitted by the management server 40 on the user terminal 10.

The reservation app 20 actually performs a golf course reservation. The reservation may also be performed by the reservation app 20 to directly automatically logging in to the golf course server 30 using the user identification information previously input by the user, and may be performed by the reservation app 20 transmitting related information to the management server 40 and the management server 40 communicating with the golf course server 30 (see FIG. 2). When the reservation is performed by the reservation app 20 to directly automatically logging in to the golf course server 30 using the user identification information previously input by the user, the information processing module 406 should be transmitted to the reservation app 20, but in this case, there is no significant difference from the case where the management server 40 performs the reservation. In the present embodiment, the management server 40 is assumed to perform the reservation. Therefore, the user's identification information may be transmitted from the reservation app 20 to the management server 40, if necessary.

In addition, for the user's reservation using the user terminal 10, the reservation app 20 includes a user identification information registration unit 210 that registers user identification information assigned as a combination of at least two or more of ID, membership number, phone number, email, password, and other matters for each golf course server 30.

The reservation app 20 may provide an initial screen in two ways: one is provided in the form of only a search window, and the other is provided in the form of a diary or calendar, which may be a form of displaying number of tees available for reservation by date.

In the supplementary description to the above description, the task of allowing the integrated reservation information DB maintenance unit 410 of the management server 40 to collect golf course reservation information from the golf course server 30 in real time and maintain the integrated reservation information DB 41 in an up-to-date state may include the following three methods.

First, the management server 40 may read reservation information from each of the golf course servers 30 using its own unique identification information and information processing module 406 for the golf course server 30 and update the integrated reservation information DB 41. In this case, the burden on the management server 40 increases, but a faster task is possible.

Second, the management server 40 may communicate with the golf course servers 30 through a unique procedure using an API or the like, receive the reservation information from the golf course server 30, and update the integrated reservation information DB 41. The method has the fastest processing speed. To this end, the method has the disadvantage of requiring a lot of cost and time since a program should be developed and installed for each golf course server 30.

Third, the management server 40 may designate the golf course servers 30 and transmits the designated golf course servers 30 to the reservation apps 20, accesses (e.g., logs in to) the golf course server 30 with user identification information using the information processing module 406 prepared for the designated golf course server 30 to retrieve information necessary for reservation from the golf course server 30 and then transmit the reservation information to the management server 40, and the management server 40 may store the transmitted reservation information to update the integrated reservation information DB 41. The method has the advantage of greatly reducing the burden on the management server 40 which should be connected to the golf course server 30 at all times.

Here, since the web page configuration is different for each golf course server 30, constructing the information processing module 406 in the form of the executable program code may be more advantageous in terms of speed. As illustrated in FIG. 1b, the information processing module 406 may additionally include an automatic login unit 406-1 that is in charge of logging in to the golf course reservation site, a reservation management unit 406-2 that is in charge of making and managing reservations on the golf course reservation site, and a membership management unit 406-3 that is in charge of automatically registering members and generating user accounts from the golf course reservation site using auxiliary identification information (to be described later) and extracts and manages membership information from the golf course reservation site. As an example of the method of using the information processing module 406 configured in this way, the management server 40 may assign golf course A to user 1 who has registered user identification information of golf course A in the reservation app 20 and assign golf course B to user 2 who has registered user identification information of the golf course B in the reservation app 20, and the reservation apps 20 of the user 1 and user 2 may each access the golf course server 30 of the golf course A and the golf course B using the information processing module 406 (e.g., using automatic login unit 406-1) and then extract guidance information using the information processing module 406 (e.g., using the reservation management unit 406-2) and transmit the extracted guidance information to the management server 40.

Now, a schematic operation flow of the system for integrative management of golf course reservation according to the present invention will be described with reference to FIG. 2. The operation flow of FIG. 2 may be more clearly understood through the description of the use case in the latter part of this specification.

The management server 40 periodically executes the information processing module 406 to collect all reservation information necessary for the golf course reservation from the reservation sites constructed on the golf course server 30, update the integrated reservation information DB 41 and the reservation start time point DB 42, and maintain the updated integrated reservation information DB 41 and reservation start time point DB 42 in an up-to-date state.

When a user executes the reservation app 20 installed on the user terminal 10 for tee reservation and inputs search conditions to request the guidance information, the management server 40 refers to the integrated reservation information DB 41 and the reservation start time point DB 42 with the received search conditions to collect real-time reservation, reservation waiting, and reservation start time point guidance information and transmits the collected real-time reservation, reservation waiting, and reservation start time point guidance information to the reservation app 20. Accordingly, the guidance information providing unit 220 of the reservation app 20 displays the guidance information on the user terminal 10 and provides the displayed guidance information to the user. For the convenience of the user, displaying the guidance information in the form of the calendar may help the user comprehensively review the reservation situation. Here, the guidance information providing unit 220 may also classify the guidance information according to the keyword entered by the user and display the classified guidance information on the user terminal 10.

Alternatively, according to another embodiment (not illustrated), when the user executes the reservation app 20 to reserve tees, the reservation app 20 requests from the management server 40 real-time reservation guidance information for a certain period of time, and the management server 40 refers to the integrated reservation information DB 41 and the reservation start time point DB 42 to collect the real-time reservation guidance information and provide the collected real-time reservation guidance information to the reservation app 20. For example, if real-time reservation guidance information for the next 4 weeks based on today's date is provided first, when there is real-time reservation guidance information that meets the user's desired conditions, the user may select the real-time reservation guidance information without having to refer to the reservation waiting guidance information and the reservation start time point guidance information and perform the reservation, which would be more convenient. When there is no real-time reservation guidance information displayed on the reservation app 20 that meets the desired conditions, if the user inputs search conditions in a way to designate a date, a golf course, or a region where the golf course is located, the reservation app 20 may transmit the search conditions to the management server 40 to request new guidance information, and the management server 40 may receive the search conditions to look up the integrated reservation information DB 41 and the reservation start time point DB 42, collect the real-time reservation guidance information, the reservation waiting guidance information, and the reservation start time point guidance information, and transmit the collected real-time reservation guidance information, reservation waiting guidance information, and reservation start time point guidance information to the reservation app 20, so the reservation app 20 may newly provide the collected real-time reservation guidance information, reservation waiting guidance information, and reservation start time point guidance information to the user.

Now, an operation flow for each guidance information is as follows.

First, when there is something that meets the desired conditions in the real-time reservation guidance information, the user may make a reservation at the corresponding golf course. To this end, the reservation app 20 refers to the selected real-time reservation guidance information (e.g., including date, time, and golf course name) to generate the reservation request information and transmits the generated reservation request information to the management server 40, thereby making the reservation request. Accordingly, the management server 40 communicates with the golf course server 30 using the API or performs a reservation task on the corresponding golf course reservation site based on the reservation request information using the information processing module 406 and transmits the reservation result notified by the golf course server 30 to the reservation app 20 to report the completion of the reservation.

As described above, this process may also be performed by the reservation app 20 automatically logging in to the golf course reservation site using the user's identification information and then accessing the golf course server 30 without the intervention of management server 40. That is, the reservation app 20 may receive the information processing module 406 of the corresponding golf course from the management server 40, and directly access the golf course reservation site using the automatic login unit 406-1 and the reservation management unit 406-2 to perform the reservation task.

Next, the user may select the provided reservation waiting guidance information to request (set) to receive a reservation availability notification. To this end, the reservation app 20 generates reservation availability notification setting information that includes at least one keyword of date, time, region, and golf course name designated by the user among the displayed reservation waiting guidance information, and transmits the generated reservation availability notification setting information to the management server 40 to request to receive the reservation availability notification, so the management server 40 stores the reservation availability notification setting information in the integrated reservation information DB 41. The management server 40 periodically collects the reservation status from the golf course server 30 to update and maintain the integrated reservation information DB 41, and when a reservation availability tee time matching the reservation availability notification setting information set (requested) by the user is looked up, the management server notifies the reservation availability notification to the reservation app 20 of the corresponding user. In this case, the management server 40 notifies the reservation availability notification according to the pre-constructed reservation availability notification processing rules (described in detail later). Now, the user may view the notified reservation availability notification and make a reservation at the corresponding golf course.

Finally, for the provided reservation start time point guidance information, when the reservation start time point guidance information includes a reservation start time point, the reservation app 20 immediately stores the reservation start time point guidance information and manages the corresponding reservation start time point (e.g., which is notified by sending an alarm to the user terminal before the arrival of the reservation start time point). On the other hand, when the reservation start time point guidance information does not include the reservation start time point, as illustrated in FIG. 2, the reservation start notification setting information including at least one keyword of the date, time, region, and golf course name designated by the user among the reservation start time point guidance information is generated and transmitted to the management server 40 to request (set) to receive the reservation start notification. Accordingly, the management server 40 performs necessary tasks according to the received reservation start notification setting information and then stores the received reservation start notification setting information in the integrated reservation information DB 41. (For example, when a user-designated desired rounding date is received, the management server 40 generates a list of golf courses for which reservations for the corresponding date have not yet started, checks the reservation start time point of each golf course included in the list in the reservation start time point DB 42, and stores the checked reservation start time point in the integrated reservation information DB 41 together with the received reservation start notification setting information.) The management server 40 periodically updates and maintains the reservation start time point DB 42, and when the reservation start time point that meets the conditions is searched, the management server notifies the reservation start notification to the user who has set to receive the reservation start notification. The reservation app 20 receives the reservation start notification and displays the reservation start notification to the user in the form of an alarm, so the user may prepare to start the reservation.

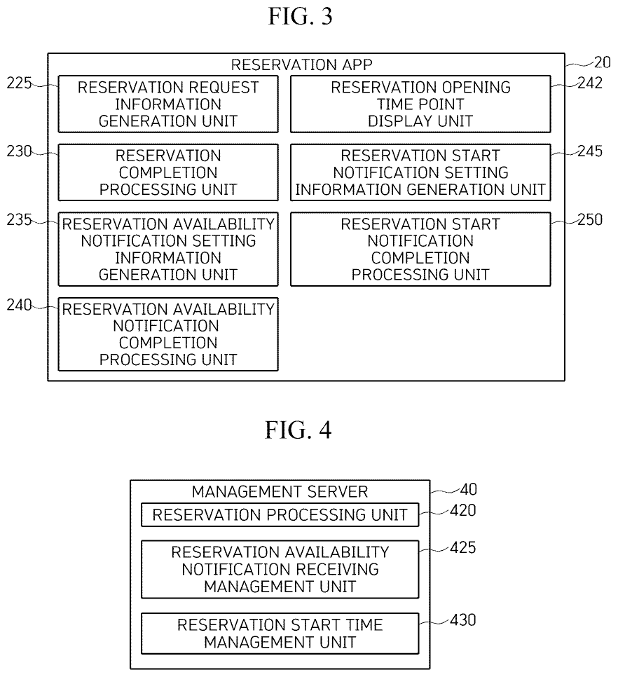

Next, the processing calculations of the three types of guidance information are described with reference to FIGS. 3 and 4. FIG. 3 illustrates additional components of the reservation app 20 shown in FIG. 1a, and FIG. 4 illustrates additional components of the management server 40 illustrated in FIG. 1a.

First, when the user who has viewed the real-time reservation guidance information provided a the guidance information providing unit 220 (FIG. 1a) of the reservation app 20 makes a reservation at the corresponding golf course, as illustrated in FIG. 3, the reservation app 20 additionally includes a reservation request information generation unit 225 that generates reservation request information including at least one keyword of the date, time, region, and golf course name designated by the user among the provided real-time reservation guidance information and transmits the generated reservation request information to the management server 40. Accordingly, as illustrated in FIG. 4, the management server 40 includes a reservation processing unit 420 which communicates with the golf course server 30 in real time to make a reservation at the corresponding golf course reservation site based on the reservation request information and notifies the reservation result to the reservation app 20. In addition, as illustrated in FIG. 3, the reservation app 20, which is notified of the reservation result, additionally includes a reservation completion processing unit 230 which performs reservation completion processing such as storing and displaying the reservation result on the display of the user terminal 10 and/or performing related calculations. In this case, the reservation completion processing unit 230 may include transmitting reservation request information to the management server 40 for later management of user's reservation details in the reservation completion processing, and the management server 40 may store the reservation request information received from the reservation app 20 as reservation confirmation information in the integrated reservation information DB 41 (FIG. 1a).

Next, the reservation waiting guidance information provided by the guidance information providing unit 220 of the reservation app 20 will be described. The user may select the reservation waiting guidance information to set (request) to receive the reservation availability notification (see FIG. 2), and at this time, the reservation availability notification setting information is generated. To this end, as illustrated in FIG. 3, the reservation app 20 additionally includes a reservation availability notification setting information generation unit 235 that generates reservation availability notification setting information including at least one keyword of the date, time, region, and golf course name designated by the user among the reservation waiting guidance information displayed by the guidance information providing unit 220 of the reservation app 20 and transmits the generated reservation availability notification setting information to the management server 40. In addition, as illustrated in FIG. 4, the management server 40 additionally includes a reservation availability notification receiving management unit 425. The reservation availability notification receiving management unit 425 receives the received reservation availability notification setting information to perform a necessary task, and then stores the received reservation availability notification setting information in the integrated reservation information DB 41, and periodically compares the received reservation availability notification setting information with the reservation availability notification setting information of the users stored in the integrated reservation information DB 41 to generate the reservation availability notification when tees available for reservation meeting conditions occur, and notifies the generated reservation availability notification to the reservation app 20 of the corresponding users according to the reservation availability notification processing rule that has been constructed in advance.

Here, when there are the same pieces of reservation availability notification setting information, the reservation availability notification processing rules may be constructed in advance to notify the reservation availability notification at time intervals in the order registered in the reservation availability notification DB (not illustrated) for each user. The reservation app 20 that has received the reservation availability notification displays the reservation availability notification on the display of the user terminal 10 in the form of a pop-up, etc., or notifies the user of the reservation availability notification by an alarm.

When the user who has received the reservation availability notification makes a reservation at the golf course in the reservation app 20, as with the real-time reservation guidance information described above, the reservation request information generation unit 225 of the reservation app 20 generates reservation request information including at least one keyword of the date, time, region, and golf course name designated by the user among the reservation availability notifications that are notified, and transmits the generated reservation request information to the management server 40. The management server 40 communicates with the golf course server 30, completes the reservation based on the received reservation request information, and notifies the reservation confirmation information (the reservation confirmation information at this time is the same as the reservation request information) to the reservation app 20. Accordingly, a reservation availability notification completion processing unit 240 of the reservation app 20 illustrated in FIG. 3 stores and displays that the reservation of the corresponding golf course has been processed in the user terminal 10 according to the received reservation confirmation information, and performs the related calculations, etc., to perform the reservation availability notification completion processing. In this case, the reservation availability notification completion processing unit 240 may include transmitting the reservation request information to the management server 40 for later management of the user, and the management server 40 may store the reservation request information received from the reservation app 20 as the reservation confirmation information in the integrated reservation information DB 41 (FIG. 1a).

Finally, the reservation start time guidance information provided by the guidance information providing unit 220 of the reservation app 20 will be described. In this case, when the reservation start time point guidance information includes the reservation start time point, a reservation start time point display unit 242 (FIG. 3) of the reservation app 20 refers to the reservation start time point immediately, executes the necessary work and then stores the reservation start time point, and displays the reservation start time point in the form of an alarm or the like when the conditions are met. On the other hand, when the reservation start time point guidance information does not include the reservation start time point, a reservation start notification setting information generation unit 245 generates reservation start notification setting information including at least one keyword of the date, region, and golf course name designated by the user among the reservation start time point guidance information displayed on the reservation app 20 and transmits the generated reservation start notification setting information to the management server 40. Accordingly, the reservation start time point management unit 430 (FIG. 4) of the management server 40 performs necessary work according to the received reservation start notification setting information and then registers the received reservation start notification setting information in the integrated reservation information DB 41. For example, when a user-designated desired rounding date is received, the management server 40 generates a list of golf courses for which reservations for the corresponding date have not yet started, checks the reservation start time point of each golf course included in the list in the reservation start time point DB 42, and registers the checked reservation start time point in the integrated reservation information DB 41 together with the received reservation start notification setting information. Thereafter, the reservation start time point management unit 430 periodically updates and maintains the reservation start time point DB 42, and notifies the reservation start notification to the user who has set to receive the reservation start notification when the conditions are met. When the reservation app 20 receives the reservation start notification, the reservation start notification completion processing unit 250 displays the reservation start notification to the user in the form of the alarm so that the user may prepare to start the reservation. In this case, for the convenience of the user's reservation, the reservation site of the corresponding golf course may be opened in a separate window on the display of the user terminal 10 and provided.

### Modified Embodiment

When the system for integrated management of golf course reservation with the basic configuration described above is implemented in the form in which each golf course is individually logged in and managed, a process of individually registering user identification information of the golf course which the user has signed up for is required. In addition, in order to automatically log in to golf course reservation sites with different configurations and exchange information, an analysis tool (e.g., information processing module 406) including program codes and data specialized for each golf course reservation site is required. Therefore, when the configuration of the golf course reservation site changes or the access path changes, the management server 40 should analyze this situation and update the reservation app 20 of the user terminal 10. In other words, one of the main tasks of the management server 40 is to periodically check whether the access path and access method of the golf course reservation site have changed, and if so, update the reservation app 20 to include the new access path and access method. In general, since most golf course reservation sites have different configurations, the information processing module 406 needs to be configured to include program codes and data specialized for each golf course reservation site. Therefore, when the configuration of the golf course reservation site changes or the access path changes, it is preferable that the management server 40 should update the reservation app 20 of the user terminal to include the corresponding information processing module 406. In this case, since it is preferable to receive and update only the information processing module 406 of the corresponding golf course other than updating the entire reservation app 20, it is advantageous that the information processing module 406 includes an automatic login unit 406-1 in charge of login, a reservation management unit 406-2 that generates and manages reservation information (meaning the above-described guidance information and all information related to reservation), and a membership management unit 406-3 that extracts membership information and automatically performs a membership registration function for an non-registered golf course, as illustrated in FIG. 1b above.

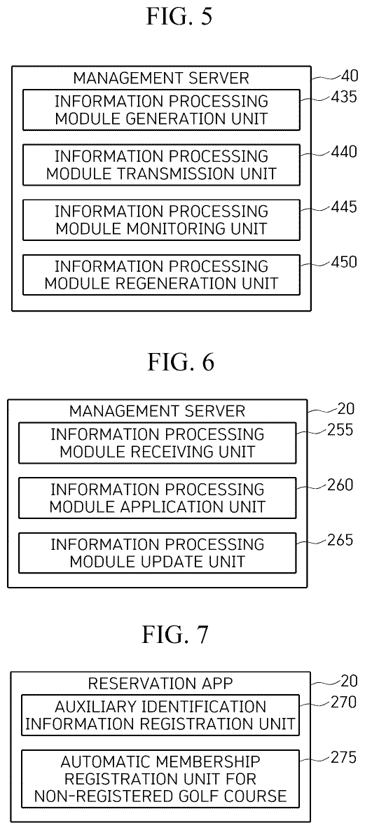

In an embodiment of the golf integrated reservation management system implemented for such a situation, as illustrated in FIG. 5, the management server 40 may additionally include an information processing module creation unit 435 that periodically analyzes whether the access path and access method of the golf course server 30 have changed, and, if changed, generates an information processing module 406 that includes a new access path and access method for each golf course reservation site which each user has signed up for, and an information processing module transmission unit 440 that transmits the information processing module 406 generated for each golf course reservation site to the reservation apps 20. Accordingly, as illustrated in FIG. 6, the reservation app 20 may additionally include an information processing module receiving unit 255 that receives and stores the information processing module 406 from the management server 40, and an information processing module application unit 260 that uses the information processing module 406 to automatically log in and perform reservation work by connecting to the golf course server 30, if necessary. The reservation app 20 may also additionally include an information processing module update unit 265 that requests the information processing module 406 including the access path and access method of the golf course registered by the user from the management server 40 and updates the stored information processing module 406.

Meanwhile, the user generally accesses the golf course server 30 through a webpage, and when the configuration of the webpage of the golf course reservation site changes, the information processing module 406 should be newly generated. Accordingly, referring to FIG. 5, the management server 40 may additionally include an information processing module monitoring unit 445 that periodically visits the golf course server 30 to check whether the webpage configuration has changed, and an information processing module regeneration unit 450 that newly generates the information processing module 406 when the configuration of the webpage has changed. In this case, the information processing module regeneration unit 450 regenerates the information processing module 406 using an information processing module extraction AI program that analyzes the meaning of sentences or words included in the changed configuration of the web page using an artificial intelligence technique, or simply, executes the web page configuration information check program on the management server 40 that reports to the administrator that the configuration of the web page has changed, and notifies the administrator when the change in the configuration of the web page is found so that the programmer may directly generate a new information processing module 406.

### Additional Example

The system for integrative management of golf course reservation according to the present invention distinguishes between a registered golf course where a user has an account by registering as a member on a golf course reservation site and a non-registered golf course where the user does not have an account. In other words, the system for integrative management of golf course reservation according to the present invention may provide the above-described guidance information and process the reservation only for registered golf courses. Therefore, in order to provide reservation services when there are empty tees at a non-registered golf course, an automatic member registration function is additionally included to automatically generate a user account (membership registration) on the relevant golf course reservation site and register the generated user account in the system of the present invention. However, in order to register as a member and generate an account, personal information should be input and, in some cases, identity verification should be performed. Therefore, in preparation for the case where users signs up for the non-registered golf course, information that may be used to configure a user ID and password (e.g., user's phone number, email address, specific characters, or symbols, etc.) is stored in advance, and automatically register as a member for the non-registered golf course, if necessary. However, even in the case of automatic membership registration, it is preferable that the user directly perform identity verification or terms and conditions agreement procedures. The ID and password of the user account generated by this automatic registration are transmitted to the user via a user's email, mobile phone, etc., so that the user may personally access the golf course reservation site later. The configuration and operation of an embodiment of the integrated golf reservation management system implemented for this case are as follows.

Referring to FIG. 7, the reservation app 20 additionally includes, separately from or within the user identification information registration unit 210 illustrated in FIG. 1a, an auxiliary identification information registration unit 270 that registers auxiliary identification information for automatically signing up for the non-registered golf course among the golf course servers 30. In order to process the user's reservation, the reservation app 20 additionally includes an automatic membership registration unit 275 for an non-registered golf course that acquires a user account by registering a new membership for the golf course server 30 of the non-registered golf course in the case where the golf course included in the reservation request information generated by the reservation request information generation unit 225 (FIG. 3) of the reservation app 20 is an non-registered golf course, and registers the user identification information of this account in the reservation app 20.

This automatic membership registration unit 275 for the non-registered golf course may perform a membership registration task of generating user identification information using information (email address, phone number, extension, etc.) previously provided by the user and automatically registering the user identification information in the non-registered golf course using the generated user identification information, and a task of automatically registering the user identification information in the reservation app 20. The automatic membership registration unit 275 for the non-registered golf courses may additionally perform the task of transmitting user identification information or other necessary information (e.g., membership terms, breach regulations, identity verification, etc.) to the user via a wireless phone call or email and requesting the confirmation when automatically registering membership in this manner. In addition, the automatic membership registration unit 275 for the non-registered golf courses may additionally perform the task of automatically canceling membership when a response from the user to the confirmation request does not arrive within a certain period of time.

### Additional Example

Due to the nature of golf games, there are many cases where people play rounds with the same companions, and usually, memories are shared through social media. However, in many cases, communication with companions continues for purposes other than golf, so a different form of approach may be necessary to share memories of a round. The system for integrative management of golf course reservation may be implemented to check whether the other person uses the services of the present invention by inputting a phone number of the other person to register the other person as a companion, and share reservation information (meaning the above-described guidance information and all information related to the reservation), round photos, simple messages, etc. In particular, since the location of the golf course and the round time are included in the reservation information for the round photos, when the user takes a photo and then designates sharing in the reservation app 20, the reservation app 20 may automatically classify and store the corresponding rounding photo to which reservation information it corresponds. The photos classified and stored in this way are automatically shared with the companions of the corresponding round through the reservation app 20, and therefore, are very useful for sharing memories between companions.

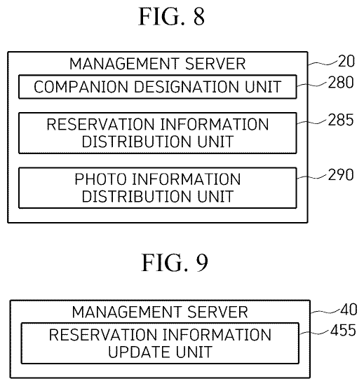

Therefore, in the system for integrative management of golf course reservation according to the present embodiment, as illustrated in FIG. 8, the reservation app 20 additionally includes a companion designation unit 280 that allows the user to designate companions with whom to share reservation information and transmits the companion designation information to the management server 40. In addition, as illustrated in FIG. 9, the management server 40 additionally includes the reservation information update unit 455 that receives companion designation information from the reservation app 20, updates the companion designation information by including the companion designation information in the reservation information, and transmits the updated reservation information to the reservation app 20. In addition, as illustrated in FIG. 8, the reservation app 20 additionally includes a reservation information distribution unit 285 that distributes the reservation information received from the management server 40 to the companions.

For example, when a user designates companion 1, companion 2, and companion 3 as “Companion 1:01722223333, Companion 2:01733334444, Companion 3:01744445555”, the companion designation unit 280 of the reservation app 20 transmits the companion information (here, phone number) to the management server 40, and the reservation information update unit 455 of the management server 40 updates the companion information by storing the companion information in the integrated reservation information DB 41 when the companions are users of the reservation app 20 and notifies the reservation app 20 of the updated reservation information. In addition, the reservation information distribution unit 285 of the reservation app 20 distributes the received reservation information to the companions.

In addition, as illustrated in FIG. 8, the reservation app 20 may additionally include a photo information distribution unit 290 that transmits the photo information selected by the user to the companions corresponding to the reservation information, in addition to the reservation information distribution unit 285. The photo information distribution unit 290 may be configured to perform a task of providing a photo album to a user to select a desired photo, a reservation information specific task of determining reservation information by comparing the location information and time information included in the photo with the golf course information and reservation time included in the reservation information previously generated by the user, a photo information addition task of including the selected photos in the determined reservation information, and a photo information distribution task of transmitting the photo information to companions of the corresponding reservation information.

### Usage Example 1

Now, a case will be described where a user named WOO downloads and installs the reservation app 20 in which the function of the present invention is implemented on his/her user terminal 10 such as a mobile phone, tablet, or PC, and uses the integrated golf course reservation management service according to the present invention.

First, it is assumed that the management server 40 receives the reservation information from the plurality of golf course servers 30 connected to the API according to a contract and acts as an agent for golf course reservations. To this end, the management server 40 communicates with the golf course servers 30 through a unique procedure according to the API, receives the guidance information from each golf course server 30, and maintains and updates the integrated reservation information DB 41.

When today is Apr. 1, 2022 and the user WOO wants to make a golf course reservation on May 6, 2022 (the desired rounding date), he/she requests the guidance information by designating the desired date as May 6 on the reservation app 20 of the user terminal 10. When requesting the guidance information, keywords (e.g., date, time, region, golf course name) for sorting the guidance information may be input together.

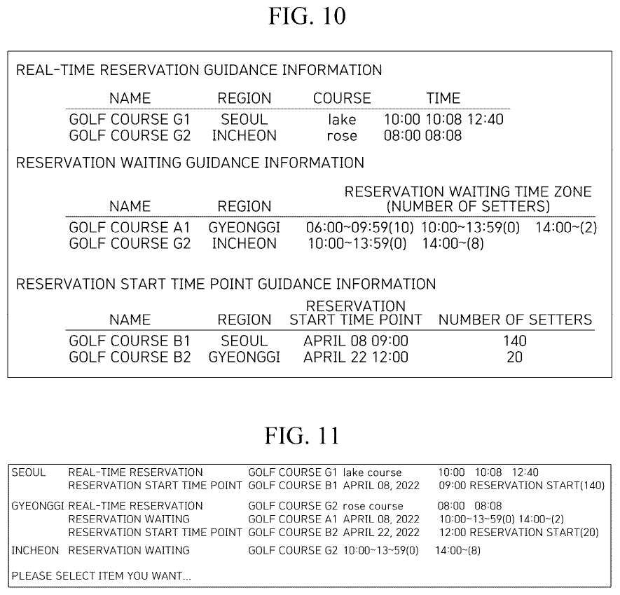

Now, the case will be described where the management server 40 collects the guidance information (i.e., real-time reservation, reservation waiting, reservation start time point guidance information) for 5 golf courses according to the guidance information request, as illustrated in FIG. 10. In FIG. 10, the number in parentheses in the reservation waiting time zone column of the reservation waiting guidance information indicates the number of users who have set to receive the reservation availability notification for the corresponding golf course during the corresponding reservation waiting time zone (see the related description in FIG. 3). For example, in the case of golf course A1, this means that 10 users have set to receive the reservation availability notification between 06:00 and 09:59.

The management server 40 transmits the collected guidance information as illustrated in FIG. 10 to the reservation app 20, and the guidance information providing unit 220 of the reservation app 20 classifies the guidance information according to the keyword input by the user and displays the classified guidance information on the display of the user terminal 10. For example, when the user sets ‘region’ as a keyword, the guidance information of FIG. 10 may be classified (sorted) according to the region as illustrated in FIG. 11 and displayed on the display (or user interface (UI) of the reservation app 20) of the user terminal 10.

First, when the user WOO wants to reserve 10:00 Tee of golf course G1 by viewing the real-time reservation guidance information among the guidance information displayed as illustrated in FIG. 11, the reservation request information generated at this time becomes [User identification information=WOO, golf course G1, lake course May 6, 2022 10:00], and the reservation app 20 transmits this reservation request information to the management server 40. The management server 40 uses the received reservation request information to communicate with reservation server 30 of the golf course G1 to process the reservation and reports the reservation result to the reservation app 20. The reservation app 20 that receives the report stores the reservation result and indicates that the reservation is completed. In this case, the reservation request information becomes the reservation confirmation information.

Next, referring to the reservation waiting guidance information among the guidance information displayed in FIG. 11, it will be described that the user generates the reservation availability notification setting information and provides the generated reservation availability notification setting information to the management server 40 to request to set the reservation availability notification. When the user WOO selects golf course A1 because he/she wants to be notified of the reservation availability notification for the golf course A1 by viewing the display in FIG. 11, the reservation app 20 additionally requests a desired time zone. This may be done, for example, with the following messaging.
Select a reservation waiting time zone for golf course A1. [1. 06:00 to 09:59 (10) 2. 10:00 to 13:59 (0) 3. 14:00˜(2)]

When the user WOO selects (2) among these, the generated reservation availability notification setting information becomes [User identification information=WOO, golf course A1, May 6, 2022 10:00 to 13:39]. The reservation app 20 transmits the reservation availability notification setting information to the management server 40. The management server 40 receives the reservation availability notification setting information, performs the necessary processing, stores the reservation availability notification setting information in the integrated reservation information DB 41, checks whether there is reservation availability notification setting information of another user set with the same conditions to determine a WOO's notification order, and transmits the determined order to the reservation app 20. Accordingly, the reservation app 20 displays the reservation availability notification setting information as follows and asks WOO for his final choice.
Reservation Availability Notification Receiving Setting Information [Golf course A1, May 6, 2022 10:00 to 13:39]: The number of setters 0, you are the first setter. Would you like to set it up? [Y/N]”

When the user WOO selects Yes, the reservation availability notification setting information confirmed as [User identification information=WOO, golf course A1, May 6, 2022 10:00 to 13:39] is stored in the integrated reservation information DB 41 of the management server 40. Thereafter, the management server 40 periodically receives the reservation status from the reservation server 30 of the golf course A1 and compares the received status with the reservation availability notification setting information stored in the integrated reservation information DB 41, and when there is a match, notifies the reservation availability notification to the reservation app 20 of WOO. The notification may be displayed in the form of a pop-up on the reservation app 20 or in another alarm method.

In this case, when the reservation availability notification processing rule is configured to notify the reservation availability notification at a time interval in the set order, the management server 40 first notifies the reservation availability notification to a first-priority user. When two users set the reservation availability notification with the same conditions at the same time, the management server 40 first notifies the reservation availability notification to the first-priority user and when the corresponding tee is still available for reservation even after the notification and response deadline (e.g., 10 minutes), notifies the reservation availability notification to a second-priority user. In this case, the reservation availability notification may be notified to the reservation app 20 of the first-priority user that the notification has been invalidated.

Meanwhile, when the management server 40 recognizes the occurrence of two tees available for reservation, the management server 40 may generate the reservation availability notification including two times, such as [User identification information=WOO, golf course A1, May 6, 2022 10:08 10:40], and transmit the generated reservation availability notification to the reservation app 20. Upon receiving the generated reservation availability notification, the reservation app 20 displays the generated reservation availability notification on the display of the user terminal 10 and notifies the user WOO, which can be displayed as follows.
Reservation Availability Notification: Golf course A1, IN course, May 6, 2022 10:00 10:40. Please select the time you wish to reserve.

In this way, when the user WOO specifies 10:00 in the reservation availability notification notified to the reservation app 20, the reservation app 20 generates the reservation request information [user real name information=WOO, golf course A1, IN course, May 6, 2022 10:00] and transmits the generated reservation request information to the management server 40. The management server 40 uses the reservation request information to communicate with the reservation server 30 of the golf course A1, thereby performing the reservation and reporting the reservation result to the reservation app 20 of the user WOO. Accordingly, the reservation app 20 performs the reservation availability notification completion processing (see FIG. 3) that stores and displays that the reservation availability notification is completed.

Finally, referring to the reservation start time point guidance information among the guidance information illustrated in FIG. 11, it will be described that the user provides the reservation start notification setting information to the reservation app 20 of the user terminal 10 to directly request to set the reservation start notification. When the user WOO selects golf course B2 to set an alarm for receiving the reservation start notification by viewing the display of FIG. 11, the reservation start notification setting information may be generated as [user identification information=WOO, golf course B2, reservation start time point=12:00, Apr. 22, 2022, alarm time point=−5]. Here, the alarm time point −5 means that the alarm will be generated at 11:55 on April 22. This setting information is stored in the user terminal 10 of the user WOO, and when [reservation start time point-alarm time point] and the current date and time match, it is displayed on the display of the user terminal 10 or an alarm is generated by other means. For example, at 11:55 p.m. on Apr. 22, 2022, an alarm occurs, such as the reservation start notification displayed on the reservation app 20 as shown below.
Reservation Start Notification: Golf course B2 Reservation for May 6, 2022 will start in 5 minutes at 12:00 on Apr. 22, 2022. Would you like to access the golf course reservation page? [Y/N]

When the user WOO selects Yes in the reservation app 20, the reservation page for the golf course B2 will be provided in a separate window so that the user may prepare to start the reservation.

### Usage Example 2

A case will be described where a user named KIM makes a reservation in the system for integrative management of golf course reservation, which is implemented in a form that allows him to manage golf courses for which he is a member.

First, the user identification information registration operation will be described.

User KIM downloads and installs the reservation app 20, which implements the function of the present invention, on his user terminal 10, such as his mobile phone, tablet, or PC, and registers user identification information such as the ID and password of the golf course server 30 where he is a member, thereby completing preparation for use. Usually, the user identification information is composed of an ID determined from one of the membership number, a mobile phone number, and email address, and a password determined by the user. Therefore, in the process of registering the identification information, the user identification information registration unit 210 of the reservation app 20 verifies whether the user is actually a member registered on the golf course reservation site. For example, it is assumed that the user KIM is a member of three golf courses as follows.

### [User Identification Information]

| Golf course name | ID | Password |
|---|---|---|
| Golf course A1 | KOREA | tree1234 |
| Golf course B1 | KOREA@gmail.com | lakewood1 |
| Golf course G1 | 01799998888 | steel123 |

When the user KIM designates the desired golf course and inputs the ID and password, the user identification information registration unit 210 of the reservation app 20 installed on the user terminal 10 checks whether the user may access each golf course server 30 with the ID and password. When the access is possible, the user identification information is registered, and when the access is not possible, it informs that the user has not registered. When the user has not registered, the user should register the user identification information on the corresponding golf course reservation site and proceed to the next operation. In this case, the auxiliary identification information registration unit 270 described in FIG. 7 may perform the automatic membership registration function for the corresponding non-registered golf course by registering the auxiliary identification information as follows.

### [Auxiliary Identification Information]

Phone number: 01799998888
Email: KOREA@gmail.com
Extension: whitepine

As described above, the user identification information registration operation is completed by registering the user identification information of the registered golf course and the auxiliary identification information for automatic membership registration of the non-registered golf course.

Next, as described above, the management server 40 periodically checks whether the access path and access method of the golf course reservation site have changed and updates the reservation app 20. For example, the management server 40 periodically visits the golf course server 30 of the golf course A1, reads a page, and compares page configuration information written in a language such as HTML or Java script with the pre-stored page configuration information to check whether the site configuration has changed. (Another way may change whether the site configuration has changed by checking whether the guidance information is normally extracted from the reservation site of the golf course A1 using the previously generated information processing module 406.) When it is determined as a result of the comparison that the reservation site configuration of the golf course A1 has changed, the management server 40 generates the new information processing module 406. When the page responsible for the login of the golf course A1 has changed, the information processing module 406 may analyze a program code configuring the login page and automatically, or if necessary, notify the administrator of the program code and allow an administrator to input a new input, thereby generating an automatic login unit 406-1. The management server 40 notifies all users who have account information (identification information) of the golf course A1 that the information processing module 406 has been newly generated and communicates with the reservation apps 20 of the users to update the information processing module 406.

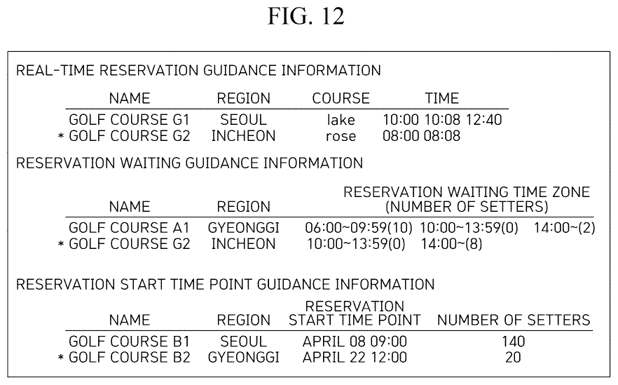

Now, a case will be described where the user KIM makes a reservation at a golf course on a specific date. When the user wants to make a reservation at a golf course on May 6, 2022, the user attempts a search by designating May 6 as the search date in the reservation app 20 of the user terminal 10. Accordingly, it is assumed that the management server 40 collects guidance information for registered golf courses A1, B1, G1 and non-registered golf courses B2 and G2 as illustrated in FIG. 12 and transmitted the collected guidance information to the reservation app 20 through the same procedure as described above. Here, the names of the non-registered golf courses are distinguished by adding*.

As illustrated in FIG. 12, when the user KIM wants to reserve a 10:00 tee time at the golf course G1 that may be reserved in real time by viewing the real-time reservation guidance information provided, the generated reservation request information is [User identification information=KIM, golf course G1, lake course May 6, 2022 10:00]. In this case, since the golf course G1 is a registered golf course, the reservation app 20 logs in to the golf course G1 reservation server 30 using the information processing module 406 of the golf course G1 (e.g., using the automatic login unit 406-1) with the user KIM's ID 01799998888 and password steel 123. Next, using the information processing module 406 (e.g., using the reservation management unit 406-2), the reservation request information [user identification information=KIM, golf course G1, lake course May 6, 2022 10:00] is input to perform the reservation. When the notification that the reservation is completed is received from the golf course G1 reservation server 30, the reservation request information is stored and displayed as the reservation confirmation information on the user terminal 10, thereby completing the real-time reservation completion operation. Meanwhile, the reservation request information may be transmitted to the management server 40 as the reservation confirmation information.

Meanwhile, when the user KIM selects the non-registered golf course G2 in the real-time reservation guidance information in FIG. 12, the following screen may be displayed on the display of the user terminal 10.
Golf course G2 is the non-registered golf course. You may use it after registering as a member (generating an account). Select 1. Automatic membership registration 2. Link to golf course membership registration page

When KIM selects ‘2’, the golf course membership registration page will pop up and guide a user to proceed with manual registration. When he/she selects ‘l’, the automatic membership registration process will be performed. In this case, the membership management unit 406-3 of the information processing module 406 may be used, and the account generation (membership registration) process using the auxiliary identification information may be performed in a separate pop-up window as shown below.
Would you like to automatically register for golf course G2 with ID 01799998888 and password whitepine? [Y/N]

If KIM selects Yes, the membership registration process will proceed, but when the personal identification process is required, the following message may be additionally output. (Additionally, you may need to agree to the membership terms or other methods of identity verification, or you may be asked for an address. In this case, the reservation app 20 can sufficiently proceed by only performing the basic procedures for reservations and later sending related links or information via a mobile phone, an email, etc., and performing additional procedures.)
The authentication number has been transmitted to mobile phone number 01799998888. Please input the 4-digit authentication number you received to verify your identity. “Authentication number=”

When the user KIM inputs the authentication number, the automatic membership registration process is completed, and the user account is generated and then the following message may be displayed. In case the user forgets, the cancellation policy or operating rules may also be transmitted.
You have signed up for golf course G2 and your account information has been automatically registered in the reservation app. The authentication number has been transmitted to mobile phone number 01799998888.
Golf course G2 Incheon rose 08:00 08:08 Reservation will be made. Please select a time.

When the user KIM wants to reserve the 08:00 tee time of the golf course G2 after viewing the message presented above, the generated reservation request information is [User identification information=KIM, golf course G2, rose course May 6, 2022 08:00]. Now, since the golf course G2 has become the registered golf course, the reservation app 20 logs in to the golf course G2 reservation server 30 using KIM's ID 01799998888 and password whitepine using the golf course G2 information processing module 406 (e.g., using the automatic login unit 406-1). Next, using the information processing module 406 (e.g., using the reservation management unit 406-2), the reservation request information [user identification information=KIM, golf course G2, rose course May 6, 2022, 08:00] is input to perform the reservation. When the reservation app 20 receives the reservation result notification from the golf course G2 reservation server 30, the reservation app 20 stores and displays the reservation request information as the reservation confirmation information on the user terminal 10 to complete the real-time reservation completion operation. Meanwhile, the reservation request information may be transmitted to the management server 40 as the reservation confirmation information.

Next, among the reservation waiting guidance information presented as in FIG. 12, when the user KIM selects the golf course A1 to request to set the reservation availability notification that he wants to be notified, the reservation app 20 additionally requests a desired time zone. For example, this may be performed in the following manner.
Select a reservation waiting time zone for golf course A1. [1. 06:00˜09:59 (10) 2. 10:00˜13:59 (0) 3. 14:00˜(2)]

When the user KIM selects (2) among these, the generated reservation availability notification setting information becomes [User identification information=KIM, golf course A1, May 6, 2022 10:00 to 13:39]. The reservation app 20 transmits the reservation availability notification setting information to the management server 40. The management server 40 stores the received reservation availability notification setting information in the integrated reservation information DB 41, checks whether there is reservation availability notification setting information of another user set with the same conditions to determine a KIM's notification order, and transmits the determined order to the reservation app 20. Accordingly, the reservation app 20 displays the reservation availability notification setting information as follows and asks WOO for his final choice.
Reservation Availability Notification Setting Information [Golf course A1, May 6, 2022 10:00 to 13:39]: The number of setters 0, you are the first setter. Would you like to set it up? [Y/N]”

When the user KIM selects Yes, the reservation availability notification setting information confirmed as [user identification information=KIM, golf course A1, May 6, 2022 10:00 to 13:39] is stored in the integrated reservation information DB 41 of the management server 40 after going through the necessary tasks. Thereafter, the management server 40 periodically receives the reservation status from the reservation server 30 of the golf course A1 and compares the received status with the reservation availability notification setting information stored in the integrated reservation information DB 41, and when there is a match, notifies the reservation availability notification to the reservation app 20 of KIM. The notification may be displayed in the form of a pop-up on the reservation app 20 or in another alarm method.

In this case, when the reservation availability notification processing rule is configured to notify the reservation availability notification at a time interval in the set order, the management server 40 first notifies the reservation availability notification to a first-priority user. When two users set the reservation availability notification with the same conditions at the same time, the management server 40 first notifies the reservation availability notification to the first-priority user and if the corresponding tee is still available for reservation even after the notification and response deadline (e.g., 10 minutes), notifies the reservation availability notification to a second-priority user. In this case, the reservation availability notification may be notified to the reservation app 20 of the first-priority user that the notification has been invalidated.

Meanwhile, when the management server 40 recognizes the occurrence of two tees available for reservation, the management server 40 may generate the reservation availability notification including two reservation availability times, such as [User identification information=KIM, golf course A1, May 6, 2022 10:08 10:40], and transmit the generated reservation availability notification to the reservation app 20. Upon receiving the generated reservation availability notification, the reservation app 20 displays the generated reservation availability notification on the display of the user terminal 10 and notifies the user WOO, which can be displayed as follows.
Reservation Availability Notification: Golf course A1, IN course May 6, 2022 10:00 10:40. “Please select the time you wish to make a reservation.”

When the user KIM wants to reserve 10:00 tee of golf course A1 after viewing the guidance information presented in this way, the reservation request information generated by the reservation app 20 becomes [User identification information=KIM, golf course A1, IN course May 6, 2022 10:00]. Since the golf course A1 is the registered golf course, the reservation app 20 logs in to the golf course A1 reservation server 30 using the user KIM's ID KOREA and password tree 1234 using the information processing module 406 of the golf course A1 (e.g., using the automatic login unit 406-1). Next, using the information processing module 406 (e.g., using the reservation management unit 406-2), the reservation request information [user identification information=KIM, golf course A1, IN course, May 6, 2022 10:00] is input to perform the reservation. When the reservation result notification is received from the golf course A1 reservation server 30, the reservation request information is stored and displayed on the user terminal 10 as the reservation confirmation information, and the reservation availability notification completion operation ends. Meanwhile, the reservation request information may be transmitted to the management server 40 as the reservation confirmation information.

In another case, when the user KIM wants to request to set the reservation availability notification for the non-registered golf course G2, the following message is output so that the automatic membership registration process may be completed before the reservation availability notification setting request is made.
Golf course G2 is a non-registered golf course. You may use it after registering as a member (generating an account). Select 1. Automatic membership registration 2. Link to golf course membership registration page

The automatic membership registration process for the non-registered golf course G2 is as described above.

Finally, for the reservation start time point guidance information displayed as in FIG. 12, when the user KIM selects the golf course B1 to request to set the reservation start notification, the reservation start notification setting information may be generated as [user identification information=KIM, golf course B1, reservation start time point=09:00 on Apr. 8, 2022, alarm time point=−5]. Here, the alarm time point −5 means that the alarm will be generated at 11:55 on April 2022. Here, the alarm time point −5 means that the alarm will be generated at 08:55 on Apr. 8, 2022. The setting information is stored in the user terminal 10 of the user KIM, and the reservation app 20 periodically compares [Reservation start time point—Alarm time point] with the current date and time, and when the [Reservation start time point—Alarm time point] and the current date and time match, displays the matched [Reservation start time point—Alarm time point] on the display of the user terminal 10 and sets an alarm. For example, at 08:55 on Apr. 8, 2022, the reservation start notification will be displayed in the reservation app 20 as follows:
Reservation Start Notification: Golf course B1. The reservation on May 6, 2022 will start in 5 minutes at 09:00 on Apr. 8, 2022. Would you like to access the golf course reservation page? [Y/N]

When the user KIM selects Yes, the reservation page for the golf course B1 is provided in a separate window so that the user may prepare for the start of the reservation.

On the other hand, when the user KIM wants to request the reservation start notification setting for the non-registered golf course B2, the message is output as follows so that the automatic account generation process is followed and the reservation start notification setting is performed. The description thereof is the same as described above, and therefore, will be omitted.
Golf course B2 is the non-registered golf course. You may use it after registering as a member (generating an account). Select 1. Automatic membership registration 2. Link to the golf course membership registration page

Hereinabove, an embodiment in which the spirit of the present invention is specifically implemented has been described. However, the technical scope of the present invention is not limited to the embodiments and drawings described above, but is defined by a rational interpretation of the claims.

1. A system for integrative management of golf course reservation, comprising:
a user terminal that performs a communication network connection and data input/output function;
a reservation app that is installed in the user terminal to be executed;
a golf course server in which a golf course reservation site accessible by the user terminal through a communication network is constructed; and
a management server that is connected to the user terminal and the golf course server through the communication network,
wherein the management server is configured to transmit, to the reservation app: 1) real-time reservation guidance information on tee times available for reservation of golf courses for which reservation is already started at a current time point, 2) reservation waiting guidance information on tee times unavailable for reservation of the golf courses for which reservation is already started at the current time point, and 3) reservation start time point guidance information on reservation start time points of golf courses for which reservation is not started yet at the current time point.

2. The system of claim 1, wherein the management server includes an information processing module that accesses the golf course server to collect the guidance information.

3. The system of claim 2, wherein the information processing module is in the form of an executable program code.

4. The system of claim 2, wherein the information processing module is configured to log in to the reservation site of the golf course server to make a reservation and to generate and manage a user account.

5. The system of claim 2, wherein the management server includes:
an information processing module generation unit that periodically analyzes whether an access path and access method of the golf course server are changed, and when one is changed, generates an information processing module including a new access path and access method for golf course reservation sites which each user signs up for; and
an information processing module transmission unit that transmits the information processing module generated for each golf course reservation site to the reservation apps.

6. The system of claim 2, wherein the reservation app includes:
an information processing module receiving unit that receives and stores the information processing module from the management server;
an information processing module application unit that uses the information processing module to access the golf course server, automatically log in to the golf course server, and perform a reservation task; and
an information processing module update unit that requests from the management server the information processing module including an access path and access method of a golf course for which a user has registered, and updates the stored information processing module.

7. The system of claim 2, wherein the management server includes:
an information processing module monitoring unit that visits the golf course server to check whether a web page configuration has changed; and
an information processing module regeneration unit that newly generates the information processing module when the web page configuration has changed.

8. The system of claim 1, wherein the management server includes an integrated reservation information DB maintenance unit that communicates with the golf course server and the user terminal to collect information necessary for golf course reservation and maintains the integrated reservation information DB in an up-to-date state.

9. The system of claim 1, wherein the management server includes a reservation start time point DB maintenance unit that maintains the reservation start time point DB in which the reservation start time points of the golf courses among the collected guidance information are stored in an up-to-date state.

10. The system of claim 1, wherein the reservation app includes an identification information registration unit that registers identification information necessary for logging in to the golf course server.

11. The system of claim 1, wherein the reservation app includes a reservation request information generation unit that generates reservation request information including a keyword designated by a user and transmits the generated reservation request information to the management server, and
the management server includes a reservation processing unit that communicates with the golf course server to complete a reservation on a corresponding golf course reservation site based on the reservation request information and notifies the reservation app that the reservation is completed.

12. The system of claim 11, wherein the reservation app additionally includes a non-registered golf course automatic membership registration unit that acquires a user account by registering a new membership for the golf course server of the corresponding non-registered golf course when the golf course included in the reservation request information generated by the reservation request information generation unit is a non-registered golf course, and registers the user identification information of the user account in the reservation app.

13. The system of claim 1, wherein the reservation app includes a reservation availability notification setting information generation unit that generates reservation availability notification setting information including a keyword designated by a user among the reservation waiting guidance information and transmits the generated reservation availability notification setting information to the management server, and
the management server includes a reservation availability notification management unit that notifies the reservation app of a reservation availability notification matching the received reservation availability notification setting information.

14. The system of claim 1, wherein the reservation app includes a reservation start time point display unit that displays a reservation start time point when the reservation start time point guidance information includes a reservation start time point, and a reservation start notification setting information generation unit that generates reservation start notification setting information including a keyword designated by a user among the reservation start time point guidance information when the reservation start time point guidance information does not include the reservation start time point and transmits the generated reservation start notification setting information to the management server, and
the management server includes a reservation start time point management unit that notifies the reservation app of a reservation start notification matching the received reservation start notification setting information.

15. The system of claim 1, wherein the reservation app includes a companion designation unit that allows a user to designate companions with whom reservation information is shared and transmits companion designation information to a management server, and
the management server includes a reservation information update unit that receives companion designation information from the reservation app, updates the reservation information by including the received companion designation information in the reservation information, and notifies the reservation app of the updated reservation information.

16. The system of claim 15, wherein the reservation app further includes a reservation information distribution unit that distributes the reservation information received from the management server to the companions.

17. A method of integrative management of golf course reservation performed by a system for integrative management of golf course reservation including a user terminal that performs a communication network connection and data input/output function, a reservation app that is installed in the user terminal to be executed, a golf course server in which a golf course reservation site accessible by the user terminal through a communication network is constructed, and a management server that is connected to the user terminal and the golf course server through the communication network, comprising;
when a user executes the reservation app and requests guidance information from the management server, collecting, by the management server, real-time reservation, reservation waiting, and reservation start time point guidance information from the golf course server to provide the collected real-time reservation, reservation waiting, and reservation start time point guidance information to the reservation app,
wherein the real-time reservation guidance information is information on tee times available for reservation of golf courses for which reservation has already started at a current time point,
the reservation waiting guidance information is information on tee times unavailable for golf courses for which reservation has already started at the current time point, and
the reservation start time point guidance information is information on reservation start time points of golf courses for which the reservation has not yet started at the current time point.

18. The method of claim 17, further comprising;
generating, by the reservation app, reservation request information including a keyword designated by the user among the provided real-time reservation guidance information to transmit the generated reservation request information to the management server to make a reservation request, and
communicating, by the management server, with the golf course server to perform reservation processing for the corresponding golf course reservation site based on the reservation request information.

19. The method of claim 17, further comprising;
generating, by the reservation app, reservation availability notification setting information including the keyword designated by the user among the provided reservation waiting guidance information to transmit the generated reservation availability notification setting information to the management server to make a setting request, and
providing, by the management server, the reservation app with a reservation availability notification matching the reservation availability notification setting information.

20. The method of claim 17, further comprising;
when the reservation start time point guidance information includes a reservation start time point, displaying, by the reservation app, the reservation start time point, and when the reservation start time point guidance information does not include the reservation start time point, generating, by the reservation app, the reservation start notification setting information including the keyword designated by the user among the reservation start time point guidance information to transmit the reservation start notification setting information to the management server, and
providing, by the management server, the reservation app with a reservation start notification matching the received reservation start notification setting information.
